(19) United States
(12) Patent Application Publication
(10) Pub. No.: US 2021/0302955 A1
(43) Pub. Date: Sep. 30, 2021

(54) Service Dispatcher for Fleet Management and Flight Planning System

(71) Applicant: LOON LLC, Mountain View, CA (US)

(72) Inventors: Sameera Sylvia Ponda, Mountain View, CA (US); Salvatore J. Candido, Mountain View, CA (US)

(73) Assignee: LOON LLC, Mountain View, CA (US)

(21) Appl. No.: 16/829,911

(22) Filed: Mar. 25, 2020

(51) Int. Cl. G05D 1/00; G05D 1/10; G08G 5/00; B64C 39/02

(52) U.S. Cl. CPC G05D 1/0027; G05D 1/1062; G05D 1/0022; B64C 2201/16; B64C 39/024; B64C 2201/104; B64C 2201/14; G08G 5/0039

(57) ABSTRACT

The technology relates to service dispatchers for fleet management and flight planning systems. A method for dispatching vehicles for service includes receiving, by a service dispatcher, a first input comprising a plurality of state data of a fleet of aerial vehicles and a second input comprising a service objective; determining, using the first input, that one or more aerial vehicles in the fleet meets a set of criteria associated with performing the service objective; submitting a bid on the one or more aerial vehicles, the bid configured to induce a vehicle allocator to allocate the one or more aerial vehicles to the service dispatcher; receiving an allocation of some or all of the one or more aerial vehicles; generating a plan to use the allocation to perform the service objective; and dispatching the allocation according to the plan.

### BACKGROUND OF INVENTION

Fleets of autonomous aerial vehicles are being considered for a variety of purposes, including providing data and network connectivity, data gathering (e.g., image capture, weather and other environmental data, telemetry), surveillance, systems testing, among others. Typically, data and network connectivity have been provided by ground infrastructure that is often expensive and not available to rural, devastated, and offshore areas. Also typically, data gathering and surveillance by aircraft has been conducted with individual aircraft being flown manually, directly piloted onboard or remotely. As these industries look to more efficient means of providing these services with fleets of autonomous vehicles, such as high altitude vehicles, the need for fleet management and flight planning for both homogeneous and heterogeneous fleets of high altitude vehicles has grown.

Conventional flight planning systems are designed typically for aerial vehicles that are manned or perform relatively short flights (i.e., minutes to hours, with a maximum of 24 hour flights). Such conventional flight planning typically is not automated and involves launching and landing aircraft directly to perform one relatively short-term mission or objective at a time, with an expectation that the aircraft will launch and land numerous times, with the capability to land in a short time frame according to a specified trajectory and flight path. Such systems are not capable of dispatching and reallocating high altitude aircraft that are designed to launch infrequently, be deployed to perform longer-term missions (i.e., days, weeks, months or years, rather than hours) and be reallocated to perform multiple objectives without landing and re-launching.

Thus, there is a need for improved dispatchers for fleet management and flight planning.

### BRIEF SUMMARY

The present disclosure provides for techniques relating to service dispatchers for fleet management and flight planning systems. A method for dispatching vehicles for service includes receiving, by a service dispatcher, a first input comprising a plurality of state data of a fleet of aerial vehicles and a second input comprising a service objective; determining, using the first input, that one or more aerial vehicles in the fleet meets a set of criteria associated with performing the service objective; submitting a bid on the one or more aerial vehicles, the bid configured to induce a vehicle allocator to allocate the one or more aerial vehicles to the service dispatcher; receiving an allocation of some or all of the one or more aerial vehicles; generating a plan to use the allocation to perform the service objective; and dispatching the allocation according to the plan.

In some examples, the method may include determining that another aerial vehicle is desired for the performance of the service objective; identifying an additional aerial vehicle in the fleet suitable for the service objective; and submitting another bid for the additional aerial vehicle. In some examples, determining that another aerial vehicle is desired includes calculating a probability that the service objective will not be fully performed by the allocation. In some examples, dispatching the allocation causes an aerial vehicle to arrive at the target service location in a given time window. In some examples, dispatching the allocation causes an aerial vehicle to remain in the target service location for a given time window.

In some examples, the method also includes causing an aerial vehicle to perform a part of the service objective related to a high bandwidth demand time window, wherein the aerial vehicle is equipped with an updated communication unit. In some examples, the method also includes causing an aerial vehicle to perform a part of the service objective related to a densely populated area, wherein the aerial vehicle is equipped with an updated communication unit. In some examples, the method also includes scheduling, by the service dispatcher, a secondary task for an aerial vehicle in the allocation. In some examples, the method also includes performing a real-time assurance check on the first input; and assigning an overriding intent to an aerial vehicle in the allocation based on the first input. In some examples, the method also includes assigning a real-time assurance controller to control the aerial vehicle's actions.

In some examples, the overriding intent comprises avoiding a no-fly zone. In some examples, the overriding intent comprises avoiding a storm. In some examples, the overriding intent comprises avoiding a zero-pressure threshold. In some examples, the overriding intent comprises avoiding a bursting threshold. In some examples, the plan schedules arrival of each aerial vehicle in the allocation to arrive at, or return to, the target service location at a respective time or time window to fulfill a coverage requirement specified by the service objective. In some examples, the service objective comprises arriving at the target service location within a given time window. In some examples, the service objective comprises providing connectivity services to the target service location for a desired time period. In some examples, the service objective comprises maximizing an amount of time the aerial vehicle is able to provide connectivity services to the target service region for a given time period. In some examples, the service objective comprises providing high level observations of the Earth. In some examples, the service objective comprises following a mapped trajectory.

A distributed computing system for fleet management and flight planning, the system includes one or more computers and one or more storage devices, the one or more storage devices storing instructions that when executed cause the one or more computers to implement; a service dispatcher configured to receive a first input comprising a plurality of state data of a fleet of aerial vehicles and a second input comprising a service objective, determine, using the first input, that one or more aerial vehicles in the fleet meets a set of criteria associated with performing the service objective, submit a bid on the one or more aerial vehicles, the bid configured to induce a vehicle allocator to allocate the one or more aerial vehicles to the service dispatcher, receive an allocation of some or all of the one or more aerial vehicles, generate a plan to use the allocation to perform the service objective, and dispatch the allocation of some or all of the one or more aerial vehicles according to the plan; and a vehicle allocator configured to allocate the fleet of aerial vehicles to one or more dispatchers.

In some examples, the one or more aerial vehicles comprise a wind-driven aerial vehicle. In some examples, the one or more aerial vehicles comprise a propulsion-capable aerial vehicle. In some examples, the one or more aerial vehicles comprise a fixed-wing aerial vehicle. In some examples, the fleet is heterogeneous. In some examples, the fleet is homogeneous.

### BRIEF DESCRIPTION OF THE DRAWINGS

FIGS. 1A-1B are diagrams of exemplary operational systems in which learned flight policies may be implemented for navigating an aerial vehicle, in accordance with one or more embodiments;

FIG. 2 is a diagram of an exemplary aerial vehicle network, in accordance with one or more embodiments;

FIG. 3A is a simplified block diagram of an exemplary computing system forming part of the systems of FIGS. 1A-2, in accordance with one or more embodiments;

FIG. 3B is a simplified block diagram of an exemplary distributed computing system, in accordance with one or more embodiments;

FIG. 4 is a simplified block diagram of an exemplary dispatch system implemented by a plurality of server computing devices, in accordance with one or more embodiments;

FIG. 5 is a simplified block diagram of an exemplary fleet management and flight planning system implementing dispatchers, in accordance with one or more embodiments;

FIG. 6 is a simplified block diagram of exemplary dispatchers dispatching vehicles, in accordance with one or more embodiments;

FIG. 7 is another simplified block diagram of exemplary dispatchers dispatching vehicles, in accordance with one or more embodiments;

FIGS. 8A-B are flow diagrams illustrating a method for obtaining an allocation of aerial vehicle(s) to a service dispatcher and dispatching the allocation of aerial vehicle(s) to perform a service objective, in accordance with one or more embodiments; and

FIG. 9 is a flow diagram illustrating an alternative method for allocating aerial vehicle(s) to a service dispatcher and dispatching the aerial vehicle(s) to perform a service objective, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for dispatching fleets of aircraft by a fleet management and flight planning system. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air vehicles (e.g., floating stratospheric balloons, other floating or wind-driving vehicles), powered lighter than air vehicles (e.g., balloons and airships with some propulsion capabilities), fixed-wing vehicles (e.g., drones, rigid kites, gliders), various types of satellites, and other high altitude aerial vehicles.

The invention is directed to a service dispatcher module in a dispatch system for fleet management and flight planning, the service dispatcher configured to handle service operation (i.e., providing coverage over service regions) for a fleet of aerial vehicles (e.g., wind-driven or other high altitude vehicles). This service dispatcher is responsible for operating flights in service zones. A vehicle that is service-ready gets allocated to the service dispatcher by a vehicle allocator, which may comprise logic and/or neural networks configured to determine to which dispatcher each vehicle in a fleet should be allocated based on various inputs.

With inputs such as the wind forecasts for a time period or time horizon, along with other inputs such as service objectives, the state of the fleet (e.g., how many balloons are available and what their capabilities are), a fleet management and flight planning system can plan what service across a given geography is desired or requested for each day in a given time horizon. Given the vehicles allocated to the service dispatcher, the service dispatcher may then schedule the number of vehicles that will service a region on a given day and allocating tasks among the service fleet. For example, for a target service location, service dispatcher may determine that X number of vehicles can arrive and/or provide service for the target service location on day 1, Y number of vehicles can provide service on day 2, Z number of vehicles can provide service on day 3, and so on. Alternatively, days 1, 2 and 3 may be time slots 1, 2 and 3, respectively, wherein the tasks are broken into time periods longer or shorter than a day (e.g., 1-, 3-, 6- or 12-hour time slots, multi-day slots, weekly slots, 15- or 30-minute slots, etc). Based on the service demand for days 1-3 at the target service location, service dispatcher may schedule some or all of X, Y and Z vehicles to the target service location. In some examples, X, Y and Z may comprise largely the same type of vehicle if the vehicles are capable of remaining in an area of the target service location efficiently (e.g., sufficient diversity of winds at different altitudes and ambient temperatures for wind-driven vehicles, efficient power expenditure profiles in view of weather forecasts for vehicles with propulsion capabilities, and the like). In other examples, X, Y and Z may comprise different types of vehicles if it is not efficient for a type of vehicle to remain in the target service location for multiple days (e.g., winds consistently blowing across the target service location where use of a higher cost vehicle with propulsion capabilities may be beneficial, extreme weather conditions that cannot be withstood by any one type of vehicle for long periods, cost constraints call for balancing minimal use of high cost vehicles with lower cost vehicles that are less efficient in certain weather conditions, and the like).

A service dispatcher may allocate tasks to be performed by one or more vehicles in performance of a service objective in various ways. Tasks can cover various aspects of a service objective. In some examples, tasks may be action-specific, wherein an assigned controller determines actions for a given vehicle to perform based on a set of actions or rules provided by a service dispatcher. In other examples, tasks may be intent-based, wherein an assigned controller may determine actions for a given vehicle to perform using simulators, Cartographer maps, or other inputs. Example tasks include, without limitation: arrive at a target service location (i.e., a region surrounding or adjacent to the target service location wherein the vehicle may begin providing services indicated in a service objective) in a certain time window, remain in the target service location for a certain time window or for a minimum amount of time, intent to service high bandwidth demand or low bandwidth demand locations or time windows based on a vehicle's communications units (e.g., better radios, updated LTE units), among other tasks. For example, a vehicle with new, updated, or otherwise higher bandwidth, communications units may be tasked with providing service at locations or times of high demand (e.g., densely populated areas, times where demand is expected to be high due to events, public celebrations, or other public gatherings), while another vehicle with older, more limited bandwidth, communications units can serve more rural, less populated, areas.

In some examples, a service dispatcher may include features beyond scheduling and task allocation. A service dispatcher may be configured to solve a variety of problems, such as, without limitation: (1) dispatching beyond a foreseeable weather forecast (e.g., beyond a certain number of days, a weather forecast may be less reliable, and the service dispatcher may be configured to plan beyond that certain number of days in several ways, including, without limitation, making assumptions, extrapolating, modeling based on historical data, re-setting its dispatch plan periodically); (2) increasing utilization by scheduling extra or secondary tasks to be performed by an aerial vehicle in addition to a primary task, as long as the performance of a secondary task does not interfere with, or further enables, performance of primary tasks; (3) enforcing stability with changing fleet sizes and other changing fleet parameters (e.g., vehicle capabilities within fleet) to maintain stable service in an area, or otherwise maintaining stability of service in changing circumstances; (4) optimizing spacing within fleet (e.g., if the winds dictate that wind-driven vehicles are expected to be able to return to a service location every X days (i.e., fly an X-day loop) and an objective is to provide continuous service for more than X days, a service dispatcher may dispatch X number of vehicles to the service location, and schedule them to each arrive at a different day, or if the loop length is Y days and you have the same X number of wind-driven vehicles, dispatcher may schedule the wind-driven vehicles to arrive in serial by a different time window, and may add or subtract (i.e, reallocate) vehicles to and from the group depending on whether Y is more or less than X); (5) maintaining real-time operations (e.g., running simulations and calculations within a predetermined computational time window to generate plans in a timely manner, and implementing protocols to account for simulations and calculations that are not completed within the predetermined computational time window); (6) maintaining software robustness by running across multiple (e.g., 3, 4 or more) data centers, including coordinating the multiple data centers to enforce a master and back-ups and escalating to manual review if the multiple data centers are not producing the same or similar results; (7) implementing fallbacks to ensure there is always a plan in place for each vehicle to steer the vehicle to a safe location, even if the vehicle experiences failures; (8) dispatching vehicles according to variable or dynamic demands (e.g., concentrating more vehicles in an area of high demand); (9) flagging dangerous times and conditions for individual vehicles (e.g., if arrival by an individual vehicle on a given day or time would result in a high probability of the vehicle entering a no-fly zone or a dangerous storm soon after, the given day or time may be flagged for the individual vehicle); (10) optimizing a fleet's revisit times to a service location (e.g., planning for periodic IoT data retrieval, periodic imaging or sensing for Earth observation, environmental data collection, and other data collection and observation programs).

In some examples, optimizing spacing may be to achieve the least or shortest outage times and/or provide the most uniform or continuous service coverage. In other examples, optimizing spacing may be to increase overall vehicle utilization by providing service only in favorable “station keeping” wind conditions (i.e., diversity of winds at or near a target location or station that would allow a wind-driven vehicle to remain in the area for a period of time) thereby providing non-uniform or non-continuous coverage.

In some examples, a variety of cost functions may be used to solve some of these problems (e.g., maximum sum subarray), such as flagging dangerous or undesirable days or times of operation. For example, a cost function may be implemented to incur a high cost (i.e., high negative number) for high probabilities of dangerous or other undesirable conditions. With a heterogeneous fleet (e.g., combination of wind-driven vehicles and propelled vehicles, combination of balloons and fixed-wing vehicles), the cost function may calculate different results for different vehicles in the fleet (i.e., what may be dangerous or undesirable for one vehicle may not be dangerous or undesirable for another).

Some aspects of generating a realistic plan to perform a service objective are more predictable, for which a service dispatcher may use rules or heuristics to approximate thresholds. Other aspects of generating a realistic plan to perform service objectives are less predictable (e.g., probability of running out of battery, probability of entering no-fly zone, etc.) due to the many uncertainties (e.g., uncertain weather forecasts, changing fleet capabilities, unexpected vehicle or system failures). In order to plan in the face of such uncertainty, a service dispatcher also may be configured to determine probabilities of achieving service objectives or tasks associated with service objectives. The service dispatcher may determine such probabilities using a combination of sampling and running simulations (e.g., using Monte Carlo or other forecasting models).

As described below, service objectives and vehicles may be allocated to a service dispatcher by a vehicle allocator according to factors such as need, priority, vehicle availability and capability, among other factors. Vehicles may be re-allocated for various reasons described herein, and a service dispatcher's planned controller or path for a vehicle allocated to it may be interrupted by a real-time assurance system according to certain overriding considerations. Such a vehicle impacted by such overriding considerations may be returned to the domain of a service dispatcher once the overriding consideration is satisfied or disappears (i.e., a condition is cleared or no longer applicable).

### Example Systems

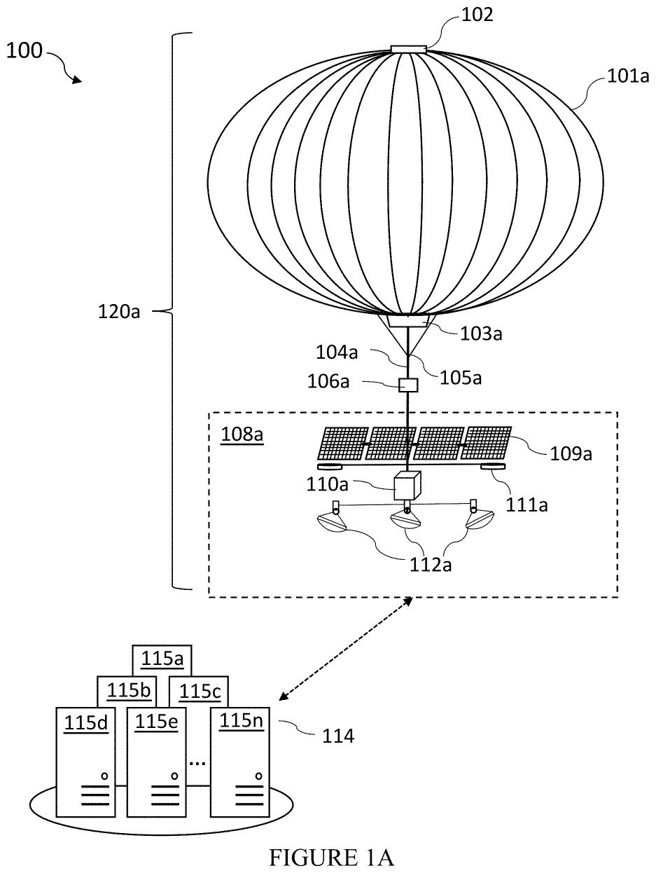

FIGS. 1A-1B are diagrams of exemplary operational systems in which flight policies may be implemented for navigating an aerial vehicle, in accordance with one or more embodiments. In FIG. 1A, there is shown a diagram of system 100 for navigation of aerial vehicle 120a. In some examples, aerial vehicle 120a may be a passive vehicle, such as a balloon or satellite, wherein most of its directional movement is a result of environmental forces, such as wind and gravity. In other examples, aerial vehicles 120a may be actively propelled. In an embodiment, system 100 may include aerial vehicle 120a and ground station 114. In this embodiment, aerial vehicle 120a may include balloon 101a, plate 102, altitude control system (ACS) 103a, connection 104a, joint 105a, actuation module 106a, and payload 108a. In some examples, plate 102 may provide structural and electrical connections and infrastructure. Plate 102 may be positioned at the apex of balloon 101a and may serve to couple together various parts of balloon 101a. In other examples, plate 102 also may include a flight termination unit, such as one or more blades and an actuator to selectively cut a portion and/or a layer of balloon 101a. ACS 103a may include structural and electrical connections and infrastructure, including components (e.g., fans, valves, actuators, etc.) used to, for example, add and remove air from balloon 101a (i.e., in some examples, balloon 101a may include an interior ballonet within its outer, more rigid shell that is inflated and deflated), causing balloon 101a to ascend or descend, for example, to catch stratospheric winds to move in a desired direction. Balloon 101a may comprise a balloon envelope comprised of lightweight and/or flexible latex or rubber materials (e.g., polyethylene, polyethylene terephthalate, chloroprene), tendons (e.g., attached at one end to plate 102 and at another end to ACS 103a) to provide strength to the balloon structure, a ballonet, along with other structural components.

Connection 104a may structurally, electrically, and communicatively, connect balloon 101a and/or ACS 103a to various components comprising payload 108a. In some examples, connection 104a may provide two-way communication and electrical connections, and even two-way power connections. Connection 104a may include a joint 105a, configured to allow the portion above joint 105a to pivot about one or more axes (e.g., allowing either balloon 101a or payload 108a to tilt and turn). Actuation module 106a may provide a means to actively turn payload 108a for various purposes, such as improved aerodynamics, facing or tilting solar panel(s) 109a advantageously, directing payload 108a and propulsion units (e.g., propellers 107 in FIG. 1B) for propelled flight, or directing components of payload 108a advantageously.

Payload 108a may include solar panel(s) 109a, avionics chassis 110a, broadband communications unit(s) 111a, and terminal(s) 112a. Solar panel(s) 109a may be configured to capture solar energy to be provided to a battery or other energy storage unit, for example, housed within avionics chassis 110a. Avionics chassis 110a also may house a flight computer (e.g., computing device 301, as described herein), a transponder, along with other control and communications infrastructure (e.g., a controller comprising another computing device and/or logic circuit configured to control aerial vehicle 120a). Communications unit(s) 111a may include hardware to provide wireless network access (e.g., LTE, fixed wireless broadband via 5G, Internet of Things (IoT) network, free space optical network or other broadband networks). Terminal(s) 112a may comprise one or more parabolic reflectors (e.g., dishes) coupled to an antenna and a gimbal or pivot mechanism (e.g., including an actuator comprising a motor). Terminal(s) 112(a) may be configured to receive or transmit radio waves to beam data long distances (e.g., using the millimeter wave spectrum or higher frequency radio signals). In some examples, terminal(s) 112a may have very high bandwidth capabilities. Terminal(s) 112a also may be configured to have a large range of pivot motion for precise pointing performance. Terminal(s) 112a also may be made of lightweight materials.

In other examples, payload 108a may include fewer or more components, including propellers 107 as shown in FIG. 1B, which may be configured to propel aerial vehicles 120a-b in a given direction. In still other examples, payload 108a may include still other components well known in the art to be beneficial to flight capabilities of an aerial vehicle. For example, payload 108a also may include energy capturing units apart from solar panel(s) 109a (e.g., rotors or other blades (not shown) configured to be spun by wind to generate energy). In another example, payload 108a may further include or be coupled to an imaging device, such as a downward-facing camera and/or a star tracker. In yet another example, payload 108a also may include various sensors (not shown), for example, housed within avionics chassis 110a or otherwise coupled to connection 104a or balloon 101a. Such sensors may include Global Positioning System (GPS) sensors, wind speed and direction sensors such as wind vanes and anemometers, temperature sensors such as thermometers and resistance temperature detectors, speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

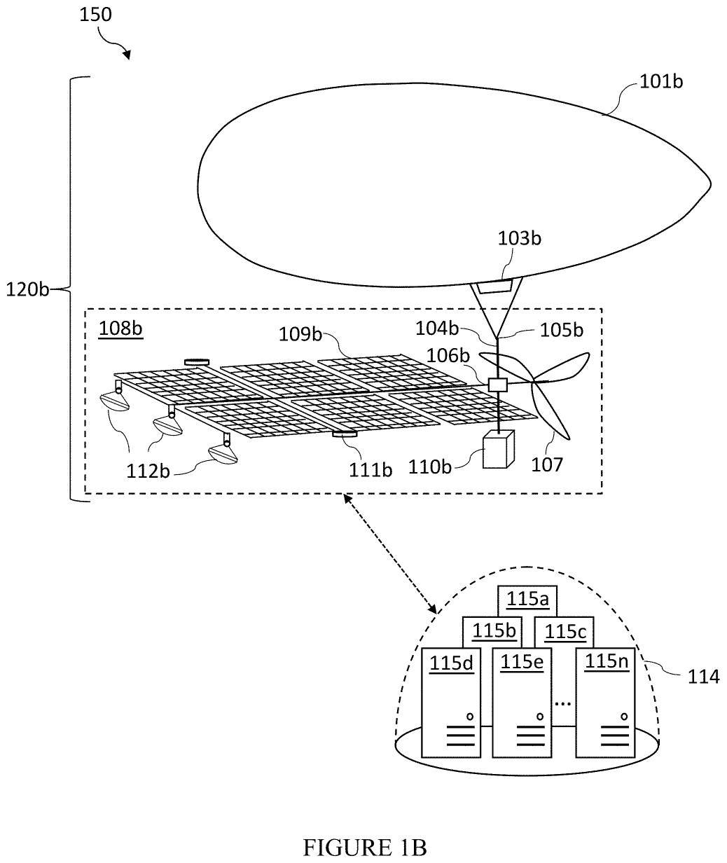

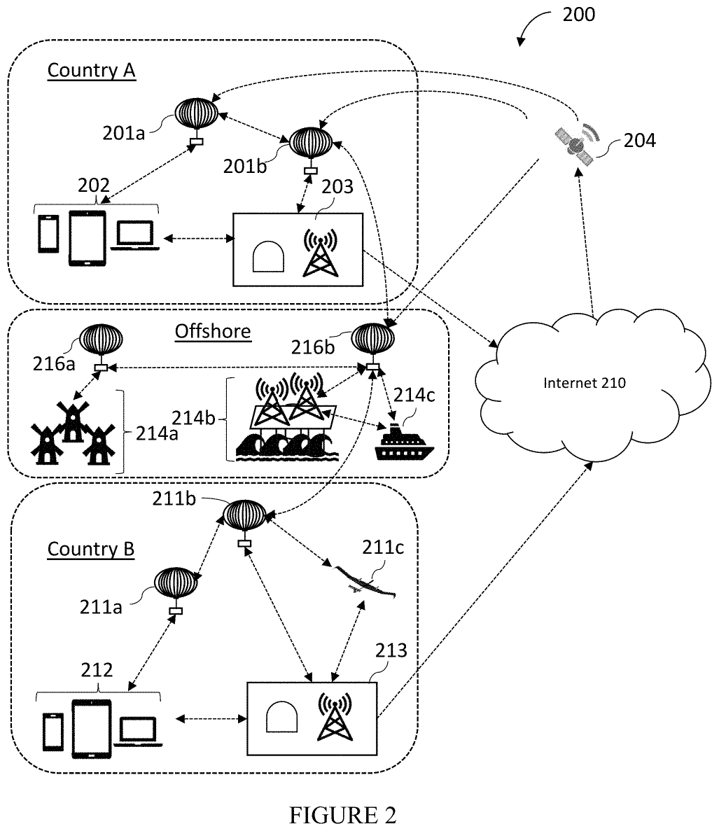

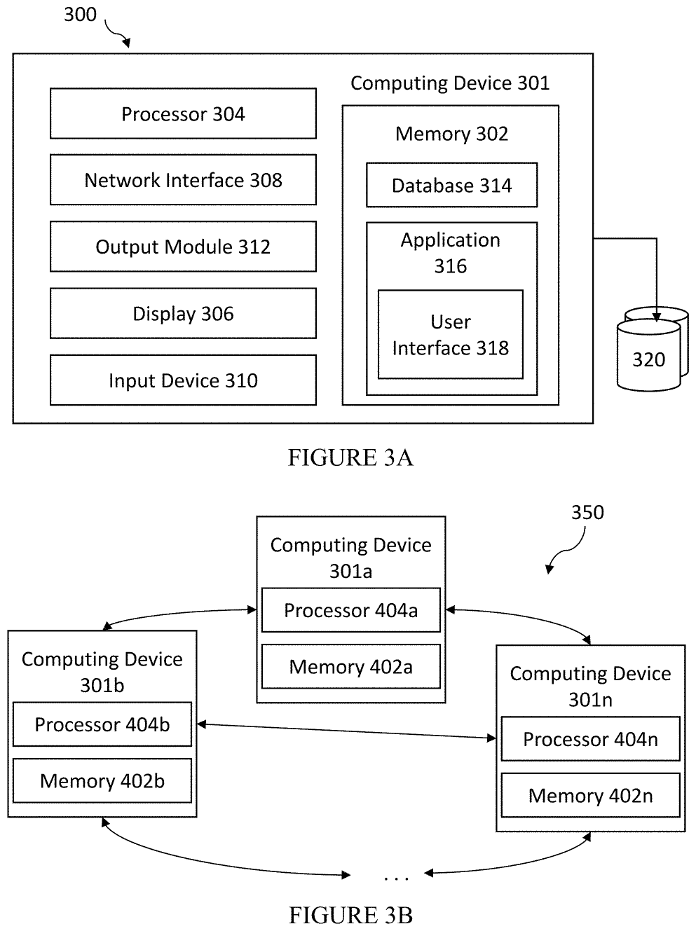

Ground station 114 may include one or more server computing devices 115a-n, which in turn may comprise one or more computing devices (e.g., computing device 301 in FIG. 3). In some examples, ground station 114 also may include one or more storage systems, either housed within server computing devices 115a-n, or separately (see, e.g., computing device 301 and repositories 320). Ground station 114 may be a datacenter servicing various nodes of one or more networks (e.g., aerial vehicle network 200 in FIG. 2).

FIG. 1B shows a diagram of system 150 for navigation of aerial vehicle 120b. All like-numbered elements in FIG. 1B are the same or similar to their corresponding elements in FIG. 1A, as described above (e.g., balloon 101a and balloon 101b may serve the same function, and may operate the same as, or similar to, each other). In this embodiment, aerial vehicle 120b further includes, as part of payload 108b, propellers 107, which may be configured to actively propel aerial vehicle 120b in a desired direction, either with or against a wind force to speed up, slow down, or re-direct, aerial vehicle 120b. In this embodiment, balloon 101b also may be shaped differently from balloon 101a, to provide different aerodynamic properties.

As shown in FIGS. 1A-1B, aerial vehicles 120a-b may be largely wind-influenced aerial vehicle, for example, balloons carrying a payload (with or without propulsion capabilities) as shown, or fixed wing high altitude drones (e.g., aerial vehicle 211c in FIG. 2) with gliding and/or full propulsion capabilities. However, those skilled in the art will recognize that the systems and methods disclosed herein may similarly apply and be usable by various other types of aerial vehicles.

FIG. 2 is a diagram of an exemplary aerial vehicle network, in accordance with one or more embodiments. Aerial vehicle network 200 may include aerial vehicles 201a-b, user devices 202, and ground infrastructure 203, in Country A. Aerial vehicle network 200 also may include aerial vehicles 211a-c, user devices 212, and ground infrastructure 213 in Country B. Aerial vehicle network 200 also may include offshore facilities 214a-c and aerial vehicles 216a-b servicing at least said offshore facilities 214a-c. Aerial network 200 may further include satellite 204 and Internet 210. Aerial vehicles 201a-b, 211a-c, and 216a-b may comprise balloon, other floating (i.e., lighter than air), propelled or partially propelled (i.e., propelled for a limited amount of time or under certain circumstances, and not propelled at other times or under other circumstances), fixed-wing, or other types of high altitude aerial vehicles, as described herein. For example, aerial vehicles 201a-b, 211a-c, and 216a-b may be the same or similar to aerial vehicles 120a-b described above. User devices 202 and 212 may include a cellular phone, tablet computer, smart phone, desktop computer, laptop computer, and/or any other computing device known to those skilled in the art. Ground infrastructure 203 and 213 may include always-on or fixed location computing device (i.e., capable of receiving fixed broadband transmissions), ground terminal (e.g., ground station 114), tower (e.g., a cellular tower), and/or any other fixed or portable ground infrastructure for receiving and transmitting various modes of connectivity described herein known to those skilled in the art. User devices 202 and 212, ground infrastructure 203 and 213, and offshore facilities 214a-c, may be capable of receiving and transmitting signals to and from aerial vehicles 201a-b, 211a-c, and 216a-b, and in some cases, to and from each other. Offshore facilities 214a-c may include industrial facilities (e.g., wind farms, oil rigs and wells), commercial transport (e.g., container ships, other cargo ships, tankers, other merchant ships, ferries, cruise ships, other passenger ships), and other offshore applications.

Aerial vehicle network 200 may support ground-to-vehicle communication and connectivity, as shown between ground infrastructure 203 and aerial vehicle 201b, as well as aerial vehicles 211b-c and ground infrastructure 213. In these examples, aerial vehicles 201b and 211b-c each may exchange data with either or both a ground station (e.g., ground station 114), a tower, or other ground structures configured to connect with a grid, Internet, broadband, and the like. Aerial vehicle network 200 also may support vehicle-to-vehicle (e.g., between aerial vehicles 201a and 201b, between aerial vehicles 211a-c, between aerial vehicles 216a-b, between aerial vehicles 201b and 216b, between aerial vehicles 211b and 216b), satellite-to-vehicle (e.g., between satellite 204 and aerial vehicles 201a-b, between satellite 204 and aerial vehicle 216b), vehicle-to-user device (e.g., between aerial vehicle 201a and user devices 202, between aerial vehicle 211a and user devices 212), and vehicle-to-offshore facility (e.g., between one or both of aerial vehicles 216a-b and one or more of offshore facilities 214a-c) communication and connectivity. In some examples, ground stations within ground infrastructures 203 and 213 may provide core network functions, such as connecting to the Internet and core cellular data network (e.g., connecting to LTE EPC or other communications platforms, and a software defined network system) and performing mission control functions. In some examples, the ground-to-vehicle, vehicle-to-vehicle, and satellite-to-vehicle communication and connectivity enables distribution of connectivity with minimal ground infrastructure. For example, aerial vehicles 201a-b, 211a-c, and 216a-b may serve as base stations (e.g., LTE eNodeB base stations), capable of both connecting to the core network (e.g., Internet and core cellular data network), as well as delivering connectivity to each other, to user devices 202 and 212, and to offshore facilities 214a-c. As such, aerial vehicles 201a-b and 211a-c represent a distribution layer of aerial vehicle network 200. User devices 202 and 212 each may access cellular data and Internet connections directly from aerial vehicles 201a-b and 211a-c.

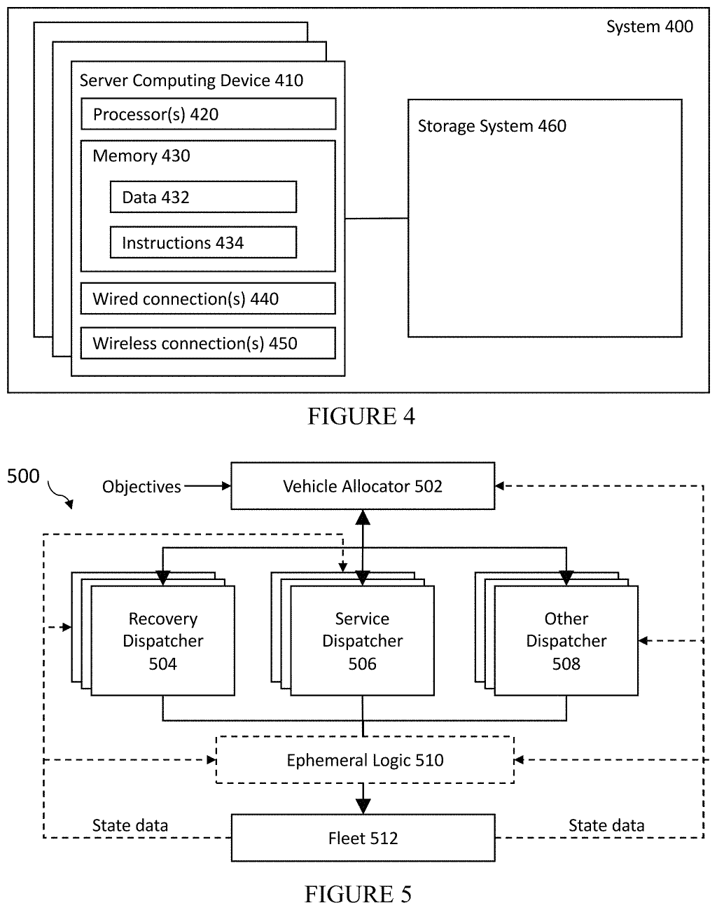

FIG. 3A is a simplified block diagram of an exemplary computing system forming part of the systems of FIGS. 1A-2, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301 (not shown). In some examples, storage system 320 may store state data, commands, flight policies, and other various types of information as described herein. This information may be retrieved or otherwise accessed by one or more computing devices, such as computing device 301 or server computing devices 410 in FIG. 4, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 400 in FIG. 3B). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., graphical user interface (GUI)). Database 314 may store various algorithms and/or data, including neural networks (e.g., encoding flight policies, as described herein) and data regarding wind patterns, weather forecasts, past and present locations of aerial vehicles (e.g., aerial vehicles 120a-b, 201a-b, 211a-c), sensor data, map information, air traffic information, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

In some examples computing device 301 may be located remote from an aerial vehicle (e.g., aerial vehicles 120a-b, 201a-b, 211a-c) and may communicate with and/or control the operations of an aerial vehicle, or its control infrastructure as may be housed in avionics chassis 110a-b, via a network. In one embodiment, computing device 301 is a data center or other control facility (e.g., configured to run a distributed computing system as described herein), and may communicate with a controller and/or flight computer housed in avionics chassis 110a-b via a network. As described herein, system 300, and particularly computing device 301, may be used for planning a flight path or course for an aerial vehicle based on wind and weather forecasts to move said aerial vehicle along a desired heading or within a desired radius of a target location. Various configurations of system 300 are envisioned, and various steps and/or functions of the processes described below may be shared among the various devices of system 300, or may be assigned to specific devices.

FIG. 3B is a simplified block diagram of an exemplary distributed computing system, in accordance with one or more embodiments. System 350 may comprise two or more computing devices 301a-n. In some examples, each of 301a-n may comprise one or more of processors 404a-n, respectively, and one or more of memory 402a-n, respectively. Processors 404a-n may function similarly to processor 304 in FIG. 3, as described above. Memory 402a-n may function similarly to memory 302 in FIG. 3, as described above.

FIG. 4 is an example of a dispatch system 400 which may be, for instance, incorporated into ground stations or other infrastructure (e.g., as shown in FIGS. 1A-1B and 2), and which may be implemented in a distributed computing system (e.g., as shown in FIG. 3B). The dispatch system 400 may include one or more server computing devices 410 and a storage system 460. A ground station may comprise a data center including storage system 460 as well as the server computing devices 410. In this regard, server computing devices 410 may function as a load balanced server farm in order to exchange information with different nodes of various networks for the purpose of receiving, processing and transmitting the data to and from other computing devices. As such, each of the one or more server computing devices 410 may include one or more processors 420, memory 430 and other components typically present in general purpose computing devices.

The memory 430 stores information accessible by the one or more processors 420, including instructions 434 and data 432 that may be executed or otherwise used by the processor 420. The memory 430 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 434 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 432 may be retrieved, stored or modified by processor 420 in accordance with the instructions 434. For instance, although the claimed subject matter is not limited by any particular data structure, the data may be stored in computing device registers, in a relational database as a table having a plurality of different fields and records, XML documents or flat files. The data may also be formatted in any computing device-readable format. For instance, data may store information about the expected location of the sun relative to the earth at any given point in time as well as information about the location of network targets.

The one or more processor 420 may be any conventional processors, such as commercially available CPUs or GPUs. Alternatively, the one or more processors may be a dedicated device such as an ASIC or other hardware-based processor. Although FIG. 4 functionally illustrates the processor, memory, and other elements of the server computing devices 410 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of server computing devices 410. Accordingly, references to a processor or computing device will be understood to include references to a collection of processors or computing devices or memories that may or may not operate in parallel.

The server computing devices 410 may also include one or more wired connections 440 and wireless connections 450 to facilitate communication with other devices, such as the storage system 460, one or more information services, and other devices of the system 100.

As with memory 430, storage system 460 can be of any type of computer storage capable of storing information accessible by the server computing devices 410, such as a hard-drive, memory card, ROM, RAM, DVD, CD-ROM, write-capable, and read-only memories. In addition, storage system 460 may include a distributed storage system where data is stored on a plurality of different storage devices which may be physically located at the same or different geographic locations. Storage system 460 may be connected to the server computing devices 410 directly (i.e. as part of server computing devices 410 and/or via wired connections 440) and/or via a network (i.e. via wired connections 440 and/or wireless connections 450). This network may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Storage system 460 and/or memory 430 may store various types of information as described in more detail below. This information may be retrieved or otherwise accessed by one or more server computing devices, such as the server computing devices 410, in order to perform some or all of the features described herein. For instance, the storage system 460 and/or memory 430 may store state information for each aerial vehicle of the fleet. This state information may include various information such as last received or current location, heading, speed, gas level, air level, other sensor data, how long the aerial vehicle has been in flight, a current mission or operational goal (i.e., objective) for the aerial vehicle, a current intent (overriding or otherwise, as described herein) for the aerial vehicle, battery information (charge, capacity, discharge rate, etc.), end of life date and/or current remaining lifetime as discussed herein, etc. The state information may also include information such as simulation of flights (e.g., comprising a series of trajectories, headings, altitudes, or the like), automated analysis of remaining lifetime, alarms that may be alerting various conditions that may be met on the system, and various other data streams produced to allow high level decision making for a fleet of aerial vehicles. In some examples, state messages and any other data may be stored in a buffer of the storage system 460 and/or memory 430, from which one or more components of the fleet management and flight planning system (e.g., a vehicle allocator, a dispatcher, or the like) may obtain state data.

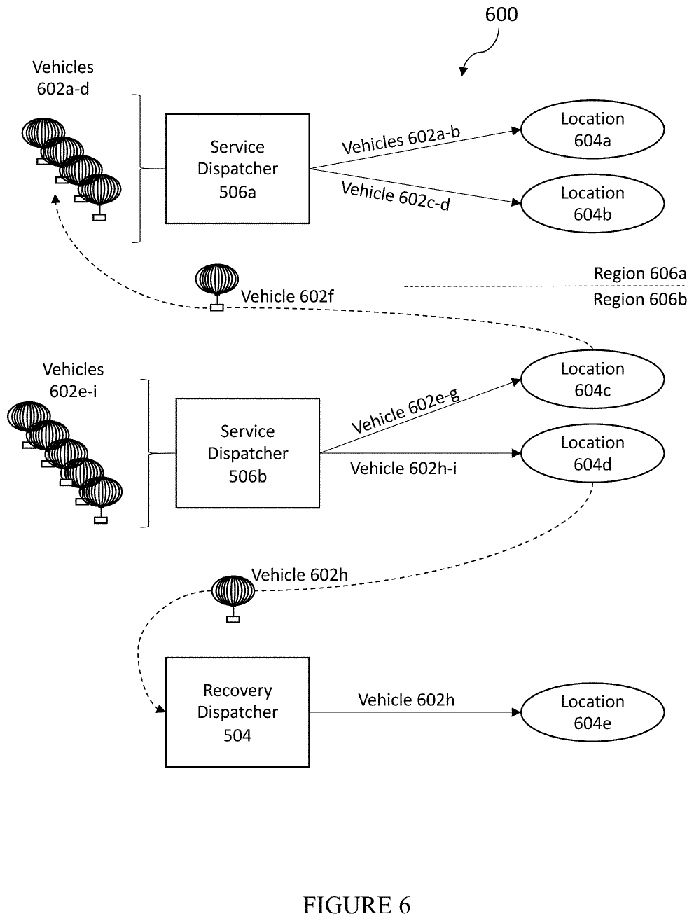

The storage system 460 and/or memory 430 may also store various software modules of the dispatch system 400. For example, the dispatch system 400 may include various software modules including one or more allocator software modules (e.g., vehicle allocator 502 in FIG. 5), a set of rules for the allocator software module, real-time assurance layer (e.g. ephemeral logic 510), as well as a plurality of dispatcher software modules (e.g., recovery dispatcher 504, service dispatcher 506, test dispatcher 508, in FIGS. 5-7, or other dispatchers). The allocator software modules may allocate each of the aerial vehicles to one of a plurality of dispatcher software modules as discussed herein.

The storage system 460 and/or memory 430 may also store current goals or objectives for the systems described herein. This may include, for instance, the number of aerial vehicles needed for a particular service, operational, testing or termination goal and/or location. These goals may be defined at least in part at the allocator software modules and/or the dispatcher software modules. For instance, changing the set of rules of the allocator software module may change how aerial vehicles are allocated. Similarly, by changing the set of rules of the dispatcher software modules, this may change the goals and intents determined by the dispatcher software module.

Storage system 460 and/or memory 430 may also store controllers, commands, navigation maps which can be used to generate flight plans, and some or all of a fleet management and flight planning system implementing dispatchers, as discussed further below. Each navigation map may be a map of wind and/or other weather data, which may be used to navigate an aerial vehicle to a particular location.

FIG. 5 is a simplified block diagram of an exemplary fleet management and flight planning system implementing dispatchers, in accordance with one or more embodiments. System 500 may include vehicle allocator 502, one or more recovery dispatcher(s) 504, one or more service dispatcher(s) 506, one or more test dispatcher(s) 508, and ephemeral logic 510. In some examples, system 500 may include one or more other dispatcher types directed to dispatching vehicles for different purposes (e.g., Earth image capture, environmental data gathering, surveillance, or other purpose). As shown, vehicle allocator 502, recovery dispatcher 504, service dispatcher 506, test dispatcher 508, and ephemeral logic 510 (if included in the system), may receive state data from fleet 512 (i.e., state data for each vehicle in fleet 512) as well as various objectives to be fulfilled by fleet 512. In some examples, ephemeral logic 510 may comprise its own vehicle allocator and set of dispatchers, for example, in parallel to vehicle allocator 502 and dispatchers 504-508, whereby an override by ephemeral logic 510 is unknown to vehicle allocator 502 (e.g., vehicle allocator 502 is unaware it is being overridden).

Such state data may originate as telemetry from aerial vehicles in fleet 512, and be augmented by various systems (e.g., flight telemetry joiners, flight data aggregators, estimators, simulators, etc.), prior to being shared with vehicle allocator 502 or dispatchers 504-508. Such state data may provide one or any combination of: current location information (e.g., latitude, longitude, altitude), current heading (e.g., trajectory, direction or range of directions traveled or expected to be traveled), battery information (e.g., charge, capacity, discharge rate, etc.), other current flight information (e.g., launch time, flight name, operational notes), vehicle age, lifetime estimation, system faults or failures, modes, software version, operational hardware capabilities, communications hardware capabilities, other vehicle configuration information (e.g., number of solar panels, serial number of support structures, etc.), and more. State data also may include meteorological data for storms or weather conditions, population density on the Earth and over which the aerial vehicles may fly, aircraft density in the air among which the aerial vehicles may fly, and other environmental data relevant to the operation of fleet 512. The state messages may be transmitted by aerial vehicles in fleet 512 to vehicle allocator 502, any dispatcher, or ephemeral logic 510 periodically, continuously, on an ad hoc basis, or another schedule. State data may also or alternatively include the output of estimators and simulators that may provide stateful derived computations from telemetry, (e.g., an estimate of remaining lift gas, projections of the aerial vehicle's trajectory and flight path).

Example objectives may include, without limitation, service objectives, such as arriving at a target service region on a given date or time window; providing connectivity services (e.g., non-terrestrial communications network services, such as LTE, internet of things, or fixed broadband service) to the target service region for a minimum, maximum, or predetermined time period (e.g., number of days, weeks, hours, daily time range indicated by start and stop times or number of hours each day, weekly time range indicated by start and stop days and times or number of days each week, and the like); otherwise maximizing or optimizing an amount of time an aerial vehicle provides connectivity services to a target service region; providing relay services to other vehicles in a mesh network (i.e., serve as a backbone to connect other vehicles to the network, for example, using balloon-to-balloon transmissions (e.g., using terminals, as described herein); providing high level earth observations (e.g., taking remote sensing measurements of the earth (e.g., using cameras, laser ranging, or other sensors), collecting and transmitting data about and for a system of Internet of things (IoT), and meteorological observations); performing other observational services (e.g., surveillance, gathering wind information, gathering other weather information); following a mapped trajectory (e.g., performing a flight that loops back to the target service region periodically) to provide services while in a target service region; other collaborative tasks to enable more efficient and precise operation by the fleet. Example objectives also may include, without limitation, test objectives, such as test objectives associated with a service region (e.g., obtaining environmental data in a service region, learning the winds in a certain region or location, or otherwise taking sensor readings in and around a service region, or other test objectives relating to observing the environment), test objectives associated with vehicle components (e.g., testing limitations of vehicle components), test objectives associated with software (e.g., testing new releases of navigation software, controllers, flight policies), and termination or landing objectives (e.g., position a vehicle to within range of a landing zone, navigate a vehicle to a landing zone by the time it reaches a predetermined minimum estimated lifetime). For example, a test objective may be to determine whether a new hardware or other components (e.g., a balloon envelope, a gimbal, a down connect, etc.) are airworthy, to collect data about said new hardware or other components, testing a new steering algorithm to understand performance and limitations, to collect data about a vehicle's and/or steering algorithm's performance to refine a simulation model, to understand the variance between vehicles of a same class (e.g. how much balloon to balloon variance is there on power draw, solar collection, ascent/descent rates, battery charge/discharge, film solar and IR absorptivity, etc), to accumulate flight-hours to unlock service flights (e.g. where an amount of flight-hours with a feature (e.g., lateral propulsion) is required over an unpopulated area (e.g., large body of water, other uninhabitable areas) to allow flight over land), to make more accurate end-of-life and reliability thresholds (e.g., to determine when different parts are going to fail).

Example objectives also may include, without limitation, other objectives layered onto any of the above objectives, such as conserving energy or minimizing energy consumption during a time period of flight or in achieving any of the aforementioned objectives; and achieving any of the aforementioned objectives in coordination with other aerial vehicles (i.e., in the context of a fleet of aerial vehicles).

Vehicle allocator 502 may be configured to allocate vehicles to recovery dispatcher 504, service dispatcher 506 and test dispatcher 508, using a set of rules, heuristics, agent-based models (e.g., bidding, auction), and machine learning models. For example, vehicle allocator 502 may entertain bids for vehicles from one or more of recovery dispatcher 504, service dispatcher 506 and test dispatcher 508, for one or more vehicles from fleet 512. For example, a dispatcher may be matched with, or assigned, a set of objectives, may determine the numbers and types of vehicles (e.g., vehicles with desired characteristics, currently located or ready to launch in a desired region) desired for optimal fulfillment of the set of objectives, and may select vehicles from fleet 512 based on these determinations to bid on. Upon receiving bids, vehicle allocator 502 may allocate one or more aerial vehicles to a dispatcher based on various factors (e.g., number of vehicles available, number of vehicles requested or bid on, priority of a region or objective). In some examples, a bid from a dispatcher may comprise a probability of successful completion of an objective with a selected aerial vehicle or set of selected aerial vehicles, which may take into account factors such as vehicle availability, priority (e.g., of region, of contract, of objective or objective type), and other factors. In other examples, a bid from a dispatcher may comprise a value indicating a likelihood of successful completion of an objective with a selected aerial vehicle or set of selected aerial vehicles. In still other examples, other allocation algorithms may be implemented (e.g. integer programming, auctions (i.e., a version of bidding that allows for re-bids or bid changes), neural network, or other logic).

There may be multiple recovery dispatchers 504, multiple service dispatchers 506, and multiple test dispatchers 508, each configured to dispatch to different geographical locations or regions, such as countries, states, municipalities, continents, island chains, bodies of water, and parts or regions thereof (e.g., Peru, State of Nevada, State of Oregon, the southwestern United States, Kenya, Northern Europe, Indonesia, French Polynesia, Queensland, Arabian Peninsula, South China Sea, Gulf of Mexico, etc.). In some examples, one or more of recovery dispatcher 504, service dispatcher 506 and test dispatcher 508 may bid on one or more objectives by determining whether the geographical region and/or purpose indicated by the objective matches with the dispatcher's domain (e.g., each of service dispatcher 506 may bid on service objectives for its respective geographical domain, each of recovery dispatcher 504 may bid on recovery objectives for its respective geographical domain or purpose, each of test dispatcher 508 may bid on test objectives for its respective geographical domain or purpose).

Each dispatcher may determine an “intent” for the aerial vehicle based on an assigned objective, the intent including at least a type of flight controller (e.g., for navigation to a destination, for station keeping around a destination, for performing system tests in a test zone, for landing in a recovery zone, etc.) and a destination (e.g., a goal or target location or region) for the aerial vehicle. The intent may additionally, or alternatively, include or represent a desired configuration (e.g., vehicle type (e.g., balloon, airship, fixed-wing, wind-driven, powered, a combination thereof or unspecified), vehicle size, communication capabilities (e.g., hardware and/or software configured for communication via a specified standard or protocol), hardware or software version or some combination thereof, for example, to support types of operational modes, flight modes, safety modes, power modes, fallback modes, communications modes, or other system or component modes).

Ephemeral logic 510 may be configured to perform real-time assurance checks based on state data that meets an overriding consideration, such as being on a heading towards and/or within a proximity of a no-fly zone or dangerous weather, or approaching zero-pressure or bursting pressure conditions. Where ephemeral logic 510 determines that an aerial vehicle's present state (e.g., location, altitude, pressure, heading) meets a condition or threshold of an overriding consideration, ephemeral logic 510 is configured to override the intent generated by a dispatcher and assign an appropriate real-time assurance controller (e.g., configured to navigate around a no-fly zone or dangerous weather, to navigate to a safe altitude, to determine an appropriate level of air intake or release or ballast drop, apply an appropriate level of propulsion for an appropriate amount of time) for the duration that the condition or threshold of the overriding condition is applicable. Once the overriding consideration is no longer applicable (e.g., aerial vehicle is past the no-fly zone or dangerous weather, has avoided dangerous pressure conditions, etc.), the aerial vehicle may continue to operate according to the intent provided by its dispatcher.

In some examples, vehicle allocator 502, any dispatcher described herein, and ephemeral logic 510, also may receive one or any combination of other inputs, including lifetime estimation for each vehicle, manual override instructions, equipment (e.g., mechanical components, hardware, software, vehicle types, etc.) requirements or preferences for each type of dispatcher (e.g., each service region, each type of objective), the demand or vehicle needs for each type of dispatcher, simulations of flights, alarms that may be alerting various conditions, and outputs of various other data streams produced to allow high level decision making for a fleet of aerial vehicles.

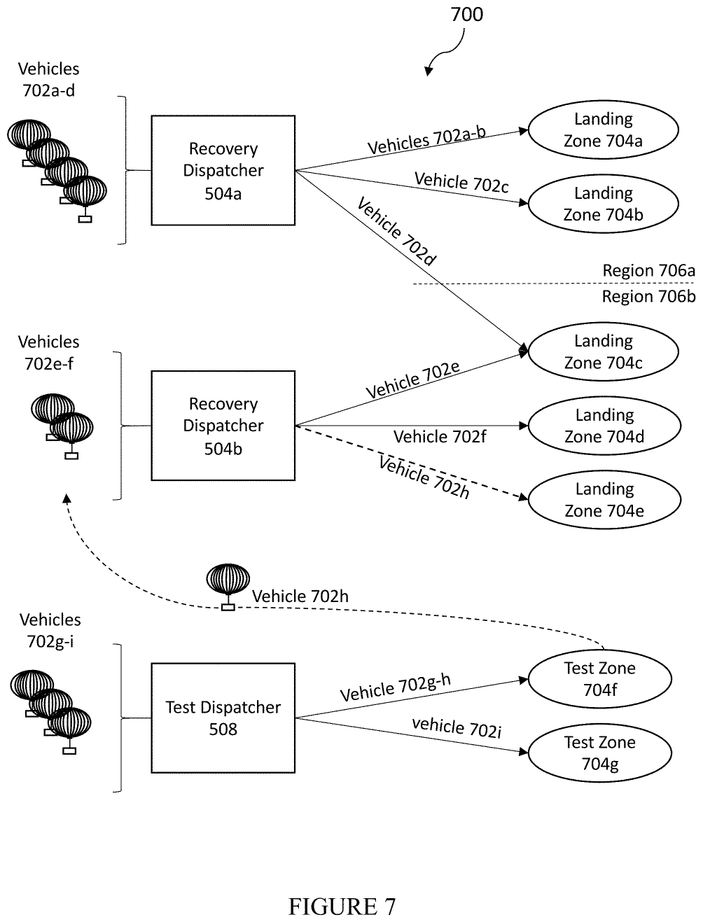

FIG. 6 is a simplified block diagram of exemplary dispatchers dispatching vehicles, in accordance with one or more embodiments. In diagram 600, vehicles 602a-d are being allocated to service dispatcher 506a, which has been configured to dispatch vehicles to target service locations within region 606a, which as described above, may include a country, body of water, state, municipality, regions within, or other parts or types of geographical locations. Within region 606a, there are exemplary target service locations 604a-b, and in an example, service dispatcher 506a may dispatch vehicles 602a-b to target service location 604a based on service objectives providing for connectivity services to target service location 604a and vehicles 602c-d to target service location 604b based on service objectives providing for connectivity services to target service location 604b. Vehicles 602e-i are being allocated to service dispatcher 506b, which has been configured to dispatch vehicles to target service locations within region 606b. Within region 606b, there are exemplary target service locations 604c-d, and in an example, service dispatcher 506b may dispatch vehicles 602e-g to target service location 604c based on service objectives providing for connectivity services to target service location 604c and vehicles 602h-i to target service location 604d based on service objectives providing for connectivity services to target service location 604d. As described herein, such service objectives may specify a service region, minimum bandwidth availability at all times, target bandwidth availability at peak times and non-peak times (e.g., mornings, afternoons, evenings, overnight, daytime, nighttime, specified hours, etc.), minimum or specified communications capabilities (e.g., 3G or 4G and up, transmit and receive certain ranges on a radio wave spectrum, etc.), minimum or required hardware and software versions, maximum age of vehicle, minimum remaining lifetime, and other aspects, as described herein.

In some examples, after performing a service objective until it is complete (i.e., fulfilled) or until the vehicle no longer meets one or more criteria for that service objective, a vehicle may be re-allocated (e.g., by vehicle allocator 502) to a different dispatcher. If the service objective for target service location 604c changes (e.g., requiring fewer vehicles going forward) or is complete, one or more of vehicles 602e-i may be re-allocated to different dispatchers. For example, if target service location 604c no longer requires as many vehicles to perform its service objective, vehicle 602f may be re-allocated (i.e., allocated for a next time period) to service dispatcher 506a to be dispatched to a service target service location within region 606a (e.g., location 604a, location 604b, or other location in region 606a). Vehicle allocator 502 may allocate vehicle 602f based on state data indicating vehicle 602f meets the criteria or conditions for service objectives associated with one or more target service locations in region 606a. For example, a current location of vehicle 602f and wind pattern information may indicate that vehicle 602f is able to navigate to a target service location for which service dispatcher 506a is responsible in time to perform a service objective in region 606a. Other state data, such as vehicle configuration, type and versioning, may indicate that vehicle 602f has the necessary capabilities to perform a service objective in region 606a. In another example, others of vehicles 602e-i may be dispatched to other target service locations within region 606b.

If one or more of vehicles 602e-i no longer meets one or more criteria for that service objective, such vehicle(s) may be re-allocated to a recovery dispatcher. For example, vehicle 602h may no longer be able to service target service location 604d after performing a service objective for target service location 604d for a while, whether or not said service objective has been fulfilled or completed. Once vehicle allocator 502 determines vehicle 602h no longer meets the criteria for target service location 604d, vehicle allocator 502 may reallocate vehicle 602h to recovery dispatcher 504, which may be configured to dispatch vehicles to decommissioned vehicle zones within region 606b such as location 604e. In an example, location 604e may comprise a landing zone selected by recovery dispatcher 508, in which vehicle 602h may be directed to land. In another example, not shown, vehicle 602h may be re-allocated to test dispatcher 508, and location 604e may comprise a test zone in which test objectives matching the state and capabilities of vehicle 602h may be performed. In another example, location 604e may overlap with a target service location for which test objectives are desired. Location 604e may be selected by test dispatcher 508 or recovery dispatcher 504 for performing tests or for landing vehicle 602h, respectively, using methods described herein.

In some examples, a dispatcher's region may encompass more than one country, state, or area (e.g., a country and adjacent body of water, a group of islands belonging to more than one country along with the surrounding or adjacent bodies of water, all the countries in a region of a continent). For example, location 604a may comprise country A and location 604b may comprise country B. Service dispatcher 506a may dispatch one or both of vehicles 602a-b to country A (location 604a) for a certain time period, then with the expectation that one or both of vehicles 602a-b may drift or otherwise navigate towards country B (location 604b) in completing part or all of a service objective for location 604a, service dispatcher 506a may dispatch one or both of vehicles 602a-b to perform part or all of a service objective for country B (location 604b).

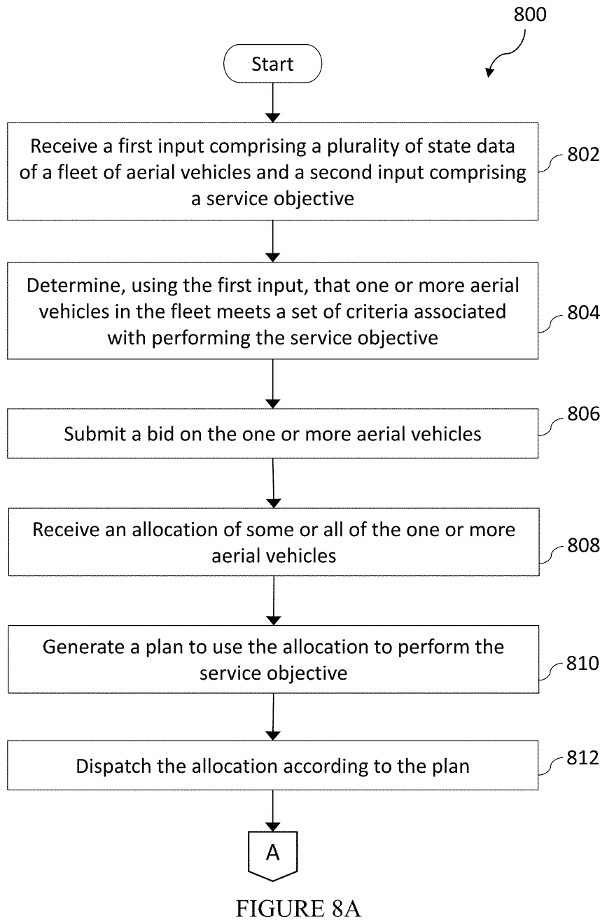

FIG. 7 is another simplified block diagram of exemplary dispatchers dispatching vehicles, in accordance with one or more embodiments. In diagram 700, vehicles 702a-d are being allocated to recovery dispatcher 504a, which has been configured to dispatch vehicles to landing zones within region 706a, vehicles 702e-f are being allocated to recovery dispatcher 504b, which has been configured to dispatch vehicles to landing zones within region 706b, and vehicles 702g-i are being allocated to test dispatcher 508, which has been configured to dispatch vehicles to test zones within region 706b. Within region 706a, there are exemplary landing zones 704a-b, and in an example, recovery dispatcher 504a may dispatch vehicles 702a-b and 702c to landing zones 704a and 704b, respectively, to perform landing objective(s) related to those locations. Within region 706b, there are exemplary landing zones 704c-e, and in an example, recovery dispatcher 504b may dispatch vehicles 702e and 702f to landing zones 704c-d, respectively, to perform landing objective(s) related to those locations. Also within region 706b, there are exemplary test zones 704f-g, and in an example, test dispatcher 508 may dispatch vehicles 702g-h and 702i to test zones 704f-g, respectively, to perform test objective(s) related to those locations. In an example, if vehicle 702h completes one or more test objectives related to test zone 704f, and it is determined that vehicle 702h meets a criterion for landing (e.g., within a threshold minimum lifetime estimate, simulations indicative of being within a lifetime estimation range required for navigating to a landing zone, unforecasted failure, manual designation for landing), for example, in nearby landing zone 704e or other landing zone. In other examples, vehicle 702h may be reallocated to another test dispatcher to perform other tests wherein vehicle 702h has not met a criterion for landing and is capable of performing further tests.

### Example Methods

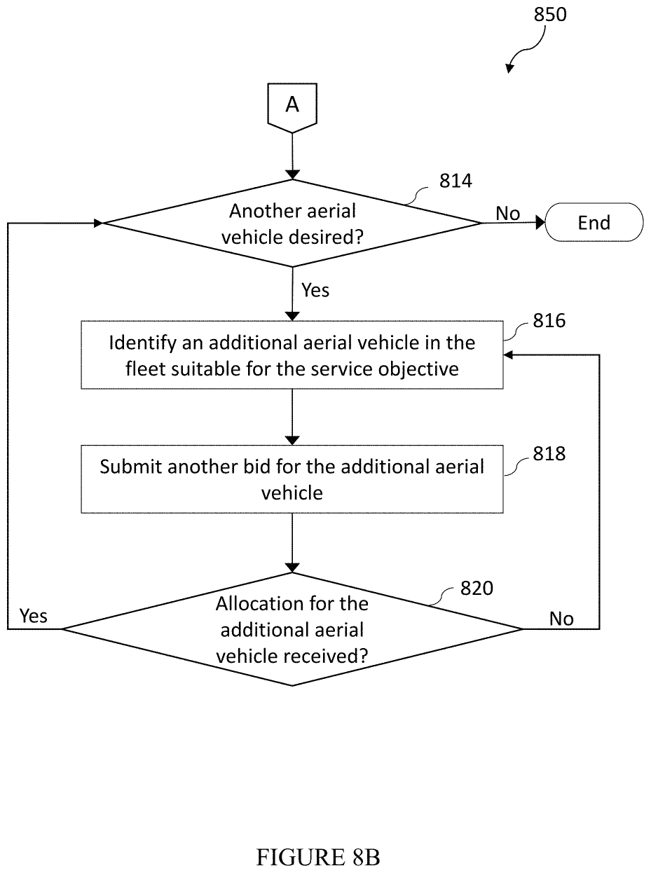

FIGS. 8A-B are flow diagrams illustrating a method for obtaining an allocation of aerial vehicle(s) to a service dispatcher and dispatching the allocation of aerial vehicle(s) to perform a service objective, in accordance with one or more embodiments. Method 800 begins with receiving a first input comprising a plurality of state data of a fleet of aerial vehicles and a second input comprising a service objective at step 802. In some examples, the state data may flow from and be amplified by a vehicle allocator or other module (e.g., flight aggregation module, telemetry backend, fleet automation response system, user command system). In other examples, the state data may be communicated directly by the aerial vehicles in the fleet. A determination may be made using the first input that one or more aerial vehicles in the fleet meets a set of criteria associated with performing the service objective at step 804. The set of criteria may include, without limitation, a length of time of service, a target service location, communications software and hardware requirements for the region, a minimum lifetime expectancy (e.g., in view of the length of time of service), among other criteria. In some examples, the determination may be made by running simulations using the first and second inputs, the simulations resulting in an output indicating how the one or more aerial vehicles may perform together to complete the service objective. Said output may comprise a range of possible subsets of the fleet along with a value (i.e., score) or a probability distribution indicating a likelihood of each subset's success at performing the service objective.

Said output may indicate an optimal number of vehicles for performing the service objective, or a range of numbers of vehicles along with a respective range of scores or probabilities of success, and may account for different types of vehicles. For example, given a homogeneous fleet, an output of simulations may indicate a range of 80% to 98% likelihood of success corresponding to a range of 8-10 vehicles. In another example, given a heterogeneous fleet, an output of simulations may indicate an 80% likelihood of success for 5 type one vehicles with 1 type two vehicle, 8 type one vehicles only, or 3 type two vehicles only, wherein type one vehicles are lower cost and type two vehicles are higher cost. In this heterogeneous fleet example, the output also may indicate possibilities up to a 98% likelihood of success for 7 type one vehicles with 2 type two vehicles, 11 type one vehicles only, or 6 type two vehicles only. Minimum probability thresholds may be predetermined to select outputs that may result in bids for vehicles. As described herein, such outputs may comprise probability distributions instead of values, and may include other information including specific identification of vehicles in the fleet rather than just types of vehicles.

In an example, where a service objective may indicate a month of service (e.g., connectivity, surveillance, or data gathering) for a target service location beginning the first of the next month, indicating a minimum of 2 vehicles be present for the same 12-hour period each day, and up to 10 lower cost wind-driven vehicles and 3 higher cost propulsion-capable vehicles available have matching capabilities for the service objective, a service dispatcher may confirm the target service location is within the service dispatcher's domain, and may cause simulations to be run to determine which combination of vehicles from the available vehicles have the highest likelihood of completing the service objective. In some examples, if the winds have sufficient diversity, a few wind-driven vehicles may be able to remain within the target service location (or in sufficient proximity to provide the requested services to the target service location) for the entire month. In other examples, if the winds are blowing across the region such that a wind-driven vehicle would be able to service the target service location for a subset of the desired 12-hour period before needing to fly a 3-day loop to return to the target service location, an optimal number may include 6 or more vehicles (e.g., more than one wind-driven vehicle per day of the loop) to be scheduled in serial to arrive within staggered time windows. In still other examples, one or more propulsion-capable and/or winged vehicle(s) facing into the wind and able to hover for part or all of the schedule using either the lift from the winds, an appropriate amount of propulsion, other forces, or a combination of these forces, may be a more efficient set of vehicles to perform this service objective (or parts thereof). In still other examples, simulations may indicate that a heterogeneous set of the available vehicles may provide the highest probability of completing the service objective.

A service dispatcher may use any or all of the information described above to submit a bid on the one or more aerial vehicles at step 806. In some examples, a service dispatcher may submit its highest bid to a vehicle allocator, and only submit less optimal bids if the highest bid is not accepted by the vehicle allocator. In other examples, a service dispatcher may submit multiple bids at once, and the vehicle allocator may select one of the multiple bids, in consideration of other bids from other dispatchers. The service dispatcher may then receive an allocation of some or all of the one or more aerial vehicles previously identified for the service objective at step 808.

Once the service dispatcher receives an allocation of vehicles, the service dispatcher may generate a plan to use the allocation of some or all of the one or more aerial vehicles to perform the service objective at step 810. In some examples, the plan may dispatch the allocation of vehicles to all arrive at a target service location on a given date (e.g., a start date indicated by the service objective). In other examples, the plan may schedule subsets of the allocation of vehicles to arrive at the target service location, such that each subset arrives at a different time or in a different time window. In some examples, the plan may include a different flight (i.e, path) for each vehicle, if they are being re-directed from different geographical locations, or are being launched at different times from the same or different launch sites. The service dispatcher may dispatch the allocation of vehicles according the plan at step 812.

In some examples, the method may continue as shown in FIG. 8B. While method 850 is being shown as a continuation of method 800, method 850 may occur in parallel with steps 810 and/or 812 of method 800, and may being anytime after the allocation of vehicles is received at step 808. A determination may be made at step 814 whether another aerial vehicle is desired. If no (e.g., the allocation is sufficient for, optimal for, or otherwise meets a threshold probability of success in, performing the service objective), then the method may end. If yes (e.g., the allocation does not include sufficient vehicle resources to meet a threshold probability of success in performing the service objective, a deficiency is identified such that a given part of the service objective is unable or unlikely to be performed, or despite a threshold probability of success being met, it is determined that an additional vehicle is available and would improve the probability of success), then an additional aerial vehicle in the fleet suitable for the service objective is identified at step 816, and another bid for the additional aerial vehicle is submitted at step 818. At step 820, if the allocation for the additional aerial vehicle is received, another determination is made whether another aerial vehicle is desired at step 814. At step 820, if the allocation for the additional aerial vehicle is not received (i.e., rejected, or otherwise not accepted or picked up, by the vehicle allocator), then the process may return to step 816 to identify another additional aerial vehicle in the fleet suitable for the service objective.

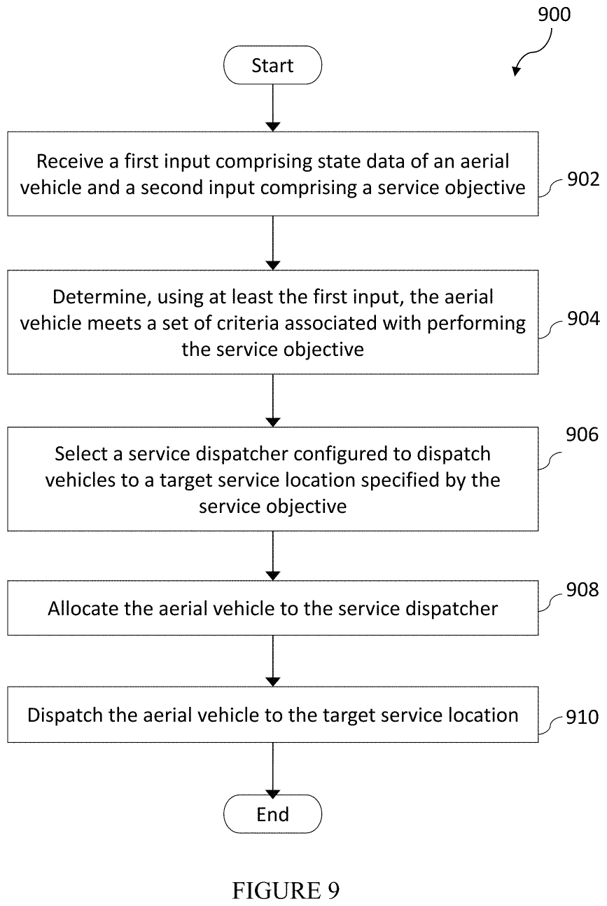

FIG. 9 is a flow diagram illustrating an alternative method for allocating aerial vehicle(s) to a service dispatcher and dispatching the aerial vehicle(s) to perform a service objective, in accordance with one or more embodiments. Method 900 begins with receiving a first input comprising state data of an aerial vehicle and a second input comprising a service objective at step 902. In some examples, this input is received by a vehicle allocator. In some examples, the vehicle allocator may receive inputs from other modules, such as a flight aggregator, lifetime estimator, other estimators, telemetry backend, or other modules configured to process and augment state data. A vehicle allocator may use at least the first input to determine that the aerial vehicle meets a set of criteria associated with performing the service objective at step 904. Examples of such criteria are described in detail above. A vehicle allocator may select a service dispatcher configured to dispatch vehicles to a target service location specified by the service objective at step 906. In some examples, the selected service dispatcher may be responsible for a geographic region, within which the target service location is located. In other examples, the selected service dispatcher may be responsible for a type of objective, of which the service objective is the type. The aerial vehicle may be allocated to the service dispatcher (i.e., selected service dispatcher) at step 908, and the selected service dispatcher may dispatch the aerial vehicle to the target service location at step 910.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A computer-implemented method comprising:
receiving, by a service dispatcher, a first input comprising a plurality of state data of a fleet of aerial vehicles and a second input comprising a service objective;
determining, using the first input, that one or more aerial vehicles in the fleet meets a set of criteria associated with performing the service objective;
submitting a bid on the one or more aerial vehicles, the bid configured to induce a vehicle allocator to allocate the one or more aerial vehicles to the service dispatcher;
receiving an allocation of some or all of the one or more aerial vehicles;
generating a plan to use the allocation to perform the service objective; and
dispatching the allocation according to the plan.

2. The method of claim 1, further comprising:
determining that another aerial vehicle is desired for the performance of the service objective;
identifying an additional aerial vehicle in the fleet suitable for the service objective; and
submitting another bid for the additional aerial vehicle.

3. The method of claim 2, wherein the determining that another aerial vehicle is desired comprises calculating a probability that the service objective will not be fully performed by the allocation.

4. The method of claim 1, wherein dispatching the allocation causes an aerial vehicle to arrive at the target service location in a given time window.

5. The method of claim 1, wherein dispatching the allocation causes an aerial vehicle to remain in the target service location for a given time window.

6. The method of claim 1, further comprising causing an aerial vehicle to perform a part of the service objective related to a high bandwidth demand time window, wherein the aerial vehicle is equipped with an updated communication unit.

7. The method of claim 1, further comprising causing an aerial vehicle to perform a part of the service objective related to a densely populated area, wherein the aerial vehicle is equipped with an updated communication unit.

8. The method of claim 1, further comprising scheduling, by the service dispatcher, a secondary task for an aerial vehicle in the allocation.

9. The method of claim 1, further comprising:
performing a real-time assurance check on the first input; and
assigning an overriding intent to an aerial vehicle in the allocation based on the first input.

10. The method of claim 9, further comprising assigning a real-time assurance controller to control the aerial vehicle's actions.

11. The method of claim 9, wherein the overriding intent comprises avoiding a no-fly zone.

12. The method of claim 9, wherein the overriding intent comprises avoiding a storm.

13. The method of claim 9, wherein the overriding intent comprises avoiding a zero-pressure threshold.

14. The method of claim 9, wherein the overriding intent comprises avoiding a bursting threshold.

15. The method of claim 1, wherein the plan schedules arrival of each aerial vehicle in the allocation to arrive at, or return to, the target service location at a respective time or time window to fulfill a coverage requirement specified by the service objective.

16. The method of claim 1, wherein the service objective comprises arriving at the target service location within a given time window.

17. The method of claim 1, wherein the service objective comprises providing connectivity services to the target service location for a desired time period.

18. The method of claim 1, wherein the service objective comprises maximizing an amount of time the aerial vehicle is to be provide connectivity services to the target service region for a given time period.

19. The method of claim 1, wherein the service objective comprises providing high level observations of the Earth.

20. The method of claim 1, wherein the service objective comprises following a mapped trajectory.

21. A distributed computing system for fleet management and flight planning, the system comprising:
one or more computers and one or more storage devices, the one or more storage devices storing instructions that when executed cause the one or more computers to implement;
a service dispatcher configured to:
receive a first input comprising a plurality of state data of a fleet of aerial vehicles and a second input comprising a service objective,
determine, using the first input, that one or more aerial vehicles in the fleet meets a set of criteria associated with performing the service objective,
submit a bid on the one or more aerial vehicles, the bid configured to induce a vehicle allocator to allocate the one or more aerial vehicles to the service dispatcher,
receive an allocation of some or all of the one or more aerial vehicles,
generate a plan to use the allocation to perform the service objective, and
dispatch the allocation of some or all of the one or more aerial vehicles according to the plan; and
a vehicle allocator configured to allocate the fleet of aerial vehicles to one or more dispatchers.

22. The system of claim 21, wherein the one or more aerial vehicles comprise a wind-driven aerial vehicle.

23. The system of claim 21, wherein the one or more aerial vehicles comprise a propulsion-capable aerial vehicle.

24. The system of claim 21, wherein the one or more aerial vehicles comprise a fixed-wing aerial vehicle.

25. The system of claim 21, wherein the fleet is heterogeneous.

26. The system of claim 21, wherein the fleet is homogeneous.
